(19) United States
(12) Patent Application Publication
(10) Pub. No.: US 2022/0087230 A1
(43) Pub. Date: Mar. 24, 2022

(54) SEMI-SUPERVISED AUDIO REPRESENTATION LEARNING FOR MODELING BEEHIVE STRENGTHS

(71) Applicant: X Development LLC, Mountain View, CA (US)

(72) Inventors: Haoyu Zhang, Los Angeles, CA (US); Szymon Zmyslony, Los Altos, CA (US)

(21) Appl. No.: 17/379,723

(22) Filed: Jul. 19, 2021

Related U.S. Application Data
(60) Provisional application No. 63/082,848, filed on Sep. 24, 2020.

(51) Int. Cl. A01K 47/06; G06N 3/04; G06N 3/08; G10L 25/18

(52) U.S. Cl. CPC A01K 47/06; G10L 25/18; G06N 3/088; G06N 3/0454

(57) ABSTRACT

Systems, methods, and non-transitory computer readable media are provided for monitoring the state of a periodic system. A computer implemented method for modeling a state of a periodic system includes inputting a spectrogram sequence to a machine-learning model trained to generate a latent representation from the spectrogram sequence. The spectrogram sequence includes a plurality of audio spectrograms representing sound generated by a periodic system. The method includes outputting the latent representation from the machine learning model. The method includes concatenating the latent representation with environmental data describing an environment of the periodic system, together defining an input sequence. The method includes inputting the input sequence to a predictor model trained to predict a state of the periodic system from the input sequence. The method also includes predicting the state of the periodic system with the predictor model.

### CROSS-REFERENCE TO RELATED APPLICATION

The instant application claims the benefit of provisional application No. 63/082,848, entitled “SEMI-SUPERVISED AUDIO REPRESENTATION LEARNING FOR MODELING BEEHIVE STRENGTHS” filed Sep. 24, 2020, the contents of which are hereby incorporated by reference in their entirety.

### TECHNICAL FIELD

This disclosure relates generally to sensor systems, and in particular but not exclusively, relates to systems and techniques for monitoring and modeling beehives.

### BACKGROUND INFORMATION

Honeybees are critical pollinators, contributing 35% of global agriculture yield. Beekeeping is dependent on human labor involving frequent inspection to ensure beehives are healthy, which can be disruptive. Increasingly, pollinator populations are declining due to threats from climate change, pests, and environmental toxicity, making improved beehive management critical.

Despite what is known about honeybee, beekeeping remains a labor intensive and experiential practice. Beekeepers rely on experience to derive heuristics for maintaining bee colonies, which necessitates frequent visual inspections of each frame of every box, many of which making up a single hive. During each inspection, beekeepers visually examine each frame and note any deformities, changes in colony size, amount of stored food, and amount of brood maintained by the bees. This process is labor intensive, limiting the number of hives that can be managed effectively without exposing bee colonies to risk of collapse. Despite growing risk factors and demand for pollination that make human inspection more difficult at scale, computational methods are unavailable for tracking beehive dynamics with a higher sampling rate, thereby limiting the scale of detailed beehive management.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1 illustrates a system for monitoring and modelling the state of a beehive, in accordance embodiments of the disclosure.

FIG. 2 illustrates a sensor bar and base unit for modelling the state of a beehive, in accordance embodiments of the disclosure.

FIG. 3 illustrates a beehive including a brood chamber and a honey super chamber, in accordance with embodiments of the disclosure.

FIG. 4 illustrates example model input data generated by a base unit including an audio spectrogram and environmental data, in accordance with embodiments the disclosure.

FIG. 5 illustrates operational components of the base unit as a block flow diagram including connectivity of constituent components of a system for modelling the state of a periodic system, in accordance with embodiments of the disclosure.

FIG. 6 illustrates data flows through an example generative-prediction network including constituent models for modelling the state of a periodic system, in accordance with embodiments of the disclosure.

FIG. 7 illustrates a block flow diagram for training the generative predictor network to predict the state of a periodic system, in accordance with embodiments of the disclosure.

FIG. 8 is a flow chart illustrating a process for monitoring the health of a beehive using machine learning (ML) models, in accordance with embodiments of the disclosure.

FIG. 9 is a flow chart illustrating a process for predicting the state of a periodic system using ML models, in accordance with embodiments of the disclosure.

In the above-referenced drawings, like reference numerals refer to like parts throughout the various views unless otherwise specified. Not all instances of an element are necessarily labeled to simplify the drawings where appropriate. The drawings are not necessarily to scale, emphasis instead being placed upon illustrating the principles being described.

### DETAILED DESCRIPTION

Embodiments of a system, a method, and computer executable instructions for modelling a state of a beehive using machine learning models trained to input audio data generated by the beehive and environmental data describing the environment of the beehive are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Embodiments of the beehive modelling system disclosed herein may be implemented using a sensor bar that may be set in a form factor to fit a frame bar (e.g., a top bar) of a honeybee frame that slides into a chamber of a beehive. While not exclusively implemented with the sensor bar, the sensor bar may include a variety of different interior environmental sensors and a microphone for monitoring the health (including activity) of the colony and the interior of the beehive. In particular, the microphone may collect audio data representing sound generated by the bees inhabiting the beehive over the course of days, weeks, or months, thereby capturing longitudinal dynamics characteristic of beehive activity, such as circadian cycles, as well as environmental dependencies. It is understood that audio data may be collected with general purpose microphones incorporated into the beehive, rather than a specialized sensor bar. Similarly, environmental data, may be monitored and recorded by individual general-purpose sensors, such as hygrometers, thermometers, and/or pressure sensors, rather than being integrated into a sensor bar.

Description of embodiments focus on beehives, but alternative applications are contemplated where semi-supervised few-shot machine learning (ML) models may be trained to predict values for state parameters describing a periodic system. In general, the techniques described may be applied to periodic systems for which some ground-truth data is available, for example, through regular albeit infrequent visits by human inspectors. Examples of alternative systems may include, but are not limited to, elevated and/or suspended roadways, liquid or gas pipelines, turbines, chemical process units, data centers, or transformer stations. In this way, an emission from the system (e.g., sound) may be monitored over time and may be combined with environmental data to be inputted to a trained ML model, with which the state of the system may be predicted. In an illustrative example, daily traffic patterns over a road bridge may result in audio patterns within the bridge structure that may be monitored by audio sensors. Paired with regular inspection of the bridge to generate sparse ground-truth data, a generative-prediction network may be trained to monitor the bridge using audio patterns and environmental data for indications of early fatigue onset.

In some embodiments, the sensors (e.g., as a sensor bar) are coupled to a base unit containing a battery, a microcontroller and memory, wireless communications (e.g., cellular radio, near-field communication controller, etc.), exterior environmental sensors for monitoring the exterior environment around the beehive, as well as other sensors (e.g., global positioning sensor). The data collected from both the interior and exterior of the beehive may be collected and combined with ground truth data from a knowledgeable beekeeper using a mobile application installed on a mobile computing device. Alternatively (or additionally), the data can be sent to a cloud-based application, which is accessed remotely. The data provides the beekeeper with real-time state of the colony and the beehive. In some embodiments, ML models may be trained using the interior and exterior sensor data, audio data generated by monitoring sound emitted by the beehive, and the ground truth data collected.

In light of the paucity of ground truth data, resulting in part from the labor and expertise involved in data collection, training may include semi-supervised learning approaches. In this way, ML models (e.g., generative-prediction models) may include both unsupervised learning models, such as convolutional models, and supervised learning models, such as fully connected feed forward networks, where the unsupervised learning models may be trained using readily available sensor data, while supervised models may be trained at least in part using labeled ground truth data.

Once trained, ML models may be incorporated into the cloud-based application and/or mobile application to monitor, track, and diagnose the health of the colony and identify stresses or other activity negatively affecting the colony. Model outputs may include a state of the system generated by multiple predictor heads, where each predictor head may be a neural network model trained to predict a state parameter.

For a beehive, state parameters may include, but are not limited, to colony population, beehive box type; queenlessness, disease type, disease severity, or swarm onset. In some embodiments, the ML models may provide the beekeeper with advance warning of health issues (e.g., colony collapse disorder, loss of the queen, number of mites per 100 bees, pesticide exposure, presence of American foulbrood, etc.) and provide recommendations for prophylactic or remedial measures. In some embodiments, wireless bandwidth and battery power may be conserved by optimizing the ML models to run on edge devices, installing the ML models onboard the base module, and only transmitting summary analysis, as opposed to the raw data, to the cloud-based application or the mobile application. These and other features of the modelling system are described below.

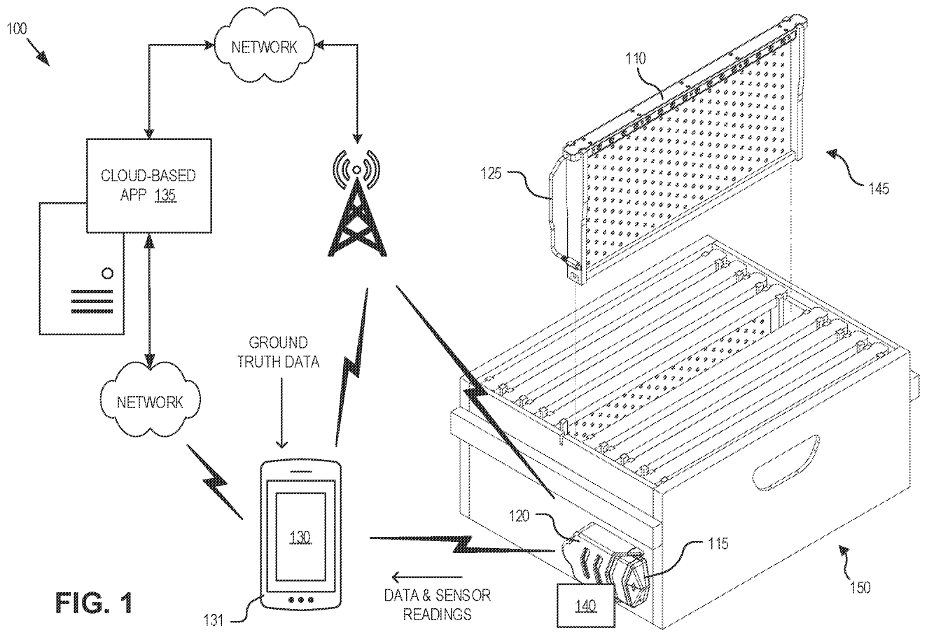

FIG. 1 illustrates a system 100 for monitoring and modelling the state of a beehive, in accordance embodiments of the disclosure. The illustrated embodiment of system 100 includes: a sensor bar 110, a base unit 115, a mount 120, a cable 125, a mobile application 130, a cloud-based application 135, and a local ML model 140. While system 100 is illustrated with sensor bar 110, it is understood that base unit 115 may be configured with one or more general purpose sensors incorporated into and/or disposed on or near the beehive and configured to monitor the beehive and the surrounding environment.

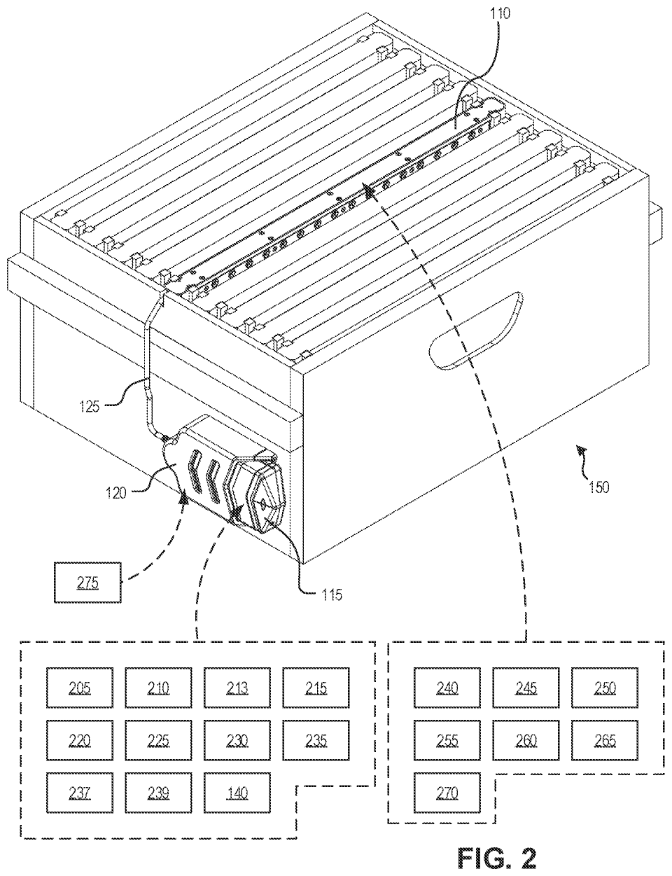

Sensor bar 110 has a form factor (e.g., size and shape) to function as a frame bar of a honeybee frame 145 that slides into a chamber 150 of a beehive (see FIG. 2). Alternatively, sensor bar 110 may have a form factor to function as a crossbar that extends across multiple frames 145 in the chamber 150 of the beehive. Chamber 150 may be a brood chamber so that sensor bar 110 can monitor the state (e.g., activity level, etc.) of the brood and the queen bee, or a honey super chamber so that sensor bar 110 can monitor the state and activity level of the worker bees. Referring to FIG. 2, sensor bar 110 is an enclosure that includes a microphone 240 to record sound emanating from within chamber 150 and through holes or ports within the enclosure. The enclosure of sensor bar 110 may further include one or more interior environmental sensors (e.g., temperature sensor 245, humidity sensor 250, carbon dioxide sensor 255, one or more other types of chemical sensors such a pollution chemical sensor 260, a pheromone chemical sensor 265, an atmospheric pressure sensor 270, etc.) that measure interior environmental characteristics. In some embodiments, sensor bar 110 may even include a sensitive accelerometer to detect movement of bees detected as physical oscillations or vibrations. Sensor bar 110 is an elongated enclosure that extends a full length between, and attaches to, adjacent perpendicular bars of honeybee frame 145. In other words, sensor bar 110 operates as a structural member of the honeybee frame 145. FIG. 1 illustrates sensor bar 110 as a top bar of honeybee frame 145; however, in other embodiments, sensor bar 110 may be implemented as a side bar, a bottom bar, or a complete replacement frame.

The sensor readings and audio data acquired by sensor bar 110 may be recorded to memory, prior to transmission to either mobile application 130 and/or cloud-based application 135. In the illustrated embodiment, sensor bar 110 is coupled with a base unit 115 via cable 125. Cable 125 is coupled with sensor bar 110, extends out of chamber 150 and couples with base unit 115. In the illustrated embodiment, base unit 115 is attached to the exterior side of chamber 150 via a mount 120. In some embodiments, cable 125 reversibly fixes to mount 120, which includes a data/power port that connects to base unit 115 when mated to mount 120. In some embodiments, mount 120 is permanently (or semi-permanently) attached to chamber 150 and includes an identifier 275 (e.g., serial number, RFID tag, etc.) that uniquely identifies chamber 150 and/or the entire beehive, of which chamber 150 is a part.

Base unit 115 may include circuitry components for storing, analyzing, and transmitting the sensor data and audio data. For example, base unit 115 may include one or more of: memory 205 (e.g., non-volatile memory such as flash memory), a microcontroller 210 to execute software instructions stored in the memory, a battery 213, a cellular radio 215 (e.g., long-term evolution machine type communication or “LTE-M” radio, or another low power wide area networking technology) for cellular data communications, a global positioning sensor (GPS) 220 to determine a location of the beehive, a near-field communication (NFC) controller 225 (e.g., Bluetooth Low Energy or “BLE”) to provide near-field data communications with portable computing device 131, and one or more external environmental sensors. For example, the external environmental sensors may include a temperature sensor 230 to monitor an exterior temperature around the beehive, a humidity sensor 235 to measure exterior humidity, one or more chemical sensors 237 to measure pollution exterior to the beehive, one or more chemical sensors 239 to measure exterior pheromones, or otherwise. In some embodiments, base unit 115 may also include an accelerometer to detect movements of the chamber or the beehive. These movements can be used to track beehive maintenance and even provide theft detection or detection of interference by wild animals.

During operation, base module 115 stores and transmits the sensor data and audio data, and in some embodiments may also provide local data processing and analysis. Mobile application 130 may help the beekeeper or other field technician find and identify a particular beehive via the wireless communications and the GPS sensor disposed onboard base unit 115. The onboard NFC controller may be used to provide tap-to-communicate services to a beekeeper carrying portable computing device 131. The stored sensor data and audio data may be wirelessly transferred to mobile application 130 using NFC protocols. In some embodiments, mobile application 130 may solicit ground truth data from a beekeeper and associate that ground truth data with the sensor data and audio data, as well as with other ancillary data (e.g., date, time, location, weather, local vegetation/crops being pollinated, etc.). The sensor data, audio data, ground truth data, and ancillary data may be analyzed with a trained ML model integrated with mobile application 130 or even by a trained ML model 140 disposed onboard base unit 115. By locally executing a trained ML model 140 either onboard base unit 115 or one integrated with mobile application 130, classified results may be pushed up to cloud-based application 135, as opposed to the raw data, which saves bandwidth and reduced power consumption on battery 213.

Cloud-based application 135 may be provided as a backend cloud-based service for gathering, storing, and/or analyzing data received either directly from base unit 115 or indirectly from mobile application 130. Initially, the raw data and ground truth data may be transmitted to cloud-based application 135 and used to train a ML model to generate one or more trained ML models, such as ML model 140. However, once sufficient data has been obtained and a ML model trained, ML model 140 may be installed directly onto base unit 115 (or integrated with mobile application 130). The onboard ML model 140 can then locally analyze and predict the state of each beehive and provide summary data or analysis to cloud-based application 135 or mobile application 130, thereby reducing bandwidth and power consumption. The summary data or analysis may provide a beekeeper with real-time tracking of data and states, environmental stress alerts, prophylactic or remedial recommendations, etc. The ML models (e.g., ML model 140) or ML models may take audio data, interior sensor data (e.g., interior temperature, humidity, carbon dioxide, chemical pollution, pheromone levels, atmospheric pressure, etc.) and exterior sensor data (e.g., exterior temperature, humidity, carbon dioxide, chemical pollution, pheromone levels, GPS location, weather conditions, atmospheric pressure, etc.) along with ground truth data and ancillary data, as input for both training and real-time prediction and/or modelling of the state of the beehive and/or chamber 150. The ground truth data may include the observations, conclusions, and informed assumptions of a beekeeper or field technician observing or managing the beehive. The combined data input from the carbon dioxide sensors, temperature sensors, humidity sensors, audio sensors, pressure sensors, and chemical sensors may be used by the ML model 140 to predict a state describing bee populations, bee activity, frame type, as well as disease type and severity, including colony collapse disorder, loss of a queen bee, the presence of American foulbrood bacteria, the number of mites per bee population, as well as other colony stresses.

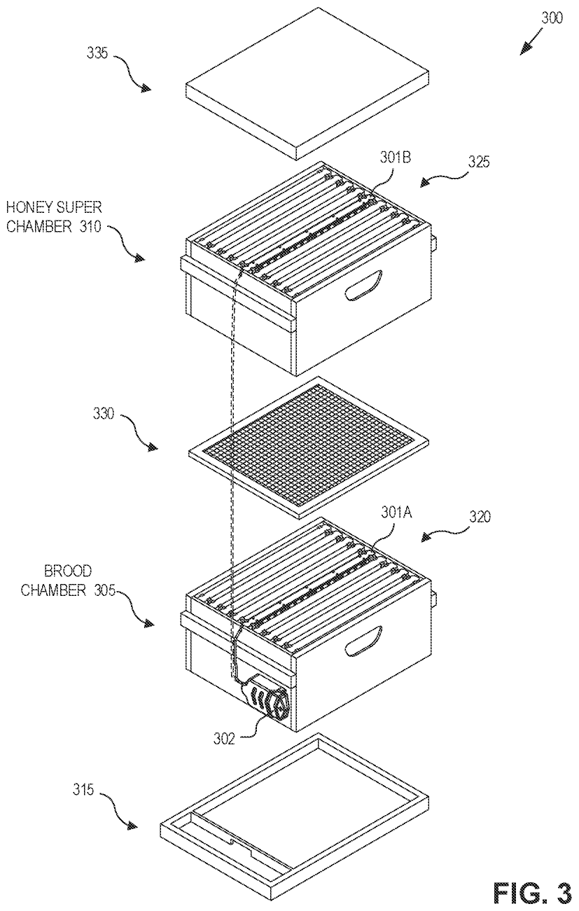

FIG. 3 illustrates a beehive 300 including a brood chamber 305 and a honey super chamber 310, in accordance with an embodiment of the disclosure. As illustrated, brood chamber 305 sits over bottom board 315 that may include an entrance, a mite floor, and a screen wire, as are common in the art of beekeeping. Brood chamber 305 includes a plurality of brood frames 320, one of which includes a sensor bar 301A. Similarly, honey super chamber 310 includes a plurality of honey frames 325, one of which includes a sensor bar 301B. Generically, brood frames 320 and honey frames 325 are referred to as honeybee frames. Although FIG. 3 illustrates just one honey super chamber 310 stacked over a single brood chamber 305, it should be appreciated that beehive 300 may include multiple stacked brood chambers 305 and multiple stacked honey super chambers 310. In the illustrated embodiment, brood chambers 305 and the honey super chambers 310 are separated by a queen excluder 330. Finally, the top of beehive 300 is capped by a cover 335, which may include a top cover and an inner cover (not separately illustrated).

FIG. 3 illustrates how a single beehive 300 may be monitored using multiple sensor bars 301 to provide differential sensing and analysis within a given beehive 300. FIG. 3 illustrates two sensor bars 301A and B providing differential data sensing and analysis vertically between brood chamber 305 and honey super chamber 310; however, it is anticipate that multiple sensor bars may even be installed into a single chamber to provide differential sensing and analysis laterally across and within a single chamber. The use of multiple sensor bars distributed both vertically and/or laterally across a single beehive 300 may provide finer grain data acquisition, thus improved hive analysis for generating ML training data and even ML prediction and/or classification during inference.

As illustrated in FIG. 3, multiple sensor bars 301A and B may couple to and share a common base unit 302. Although FIG. 3 illustrates wired connections between base unit 302 and sensor bars 301, in other embodiments, wireless connections between sensor bars 301 and base unit 302 may be implemented. For example, sensor bars 301 may incorporate their own batteries and use low power wireless data communications to base unit 302. Alternatively (or additionally), base unit 302 may also provide inductive power to sensor bars 301. In yet other embodiments, the cellular radio, battery, GPS sensor, memory, and/or microcontroller may be entirely integrated into the sensor bar, and the base unit may simply include exterior environmental sensors and potentially a GPS or cellular antenna. In yet other embodiments, the exterior base unit may be entirely omitted. In another embodiment, the chambers of beehive 300 may be modified to include power rails that distribute power from a battery pack contained in or on the box structure of beehive 300 to one or more sensor bars. In some embodiments, low power wireless mesh networking protocols may be used to link multiple sensor bars within a particular beehive or across a field of beehives to provide a single ingress/egress data gateway for external network communications.

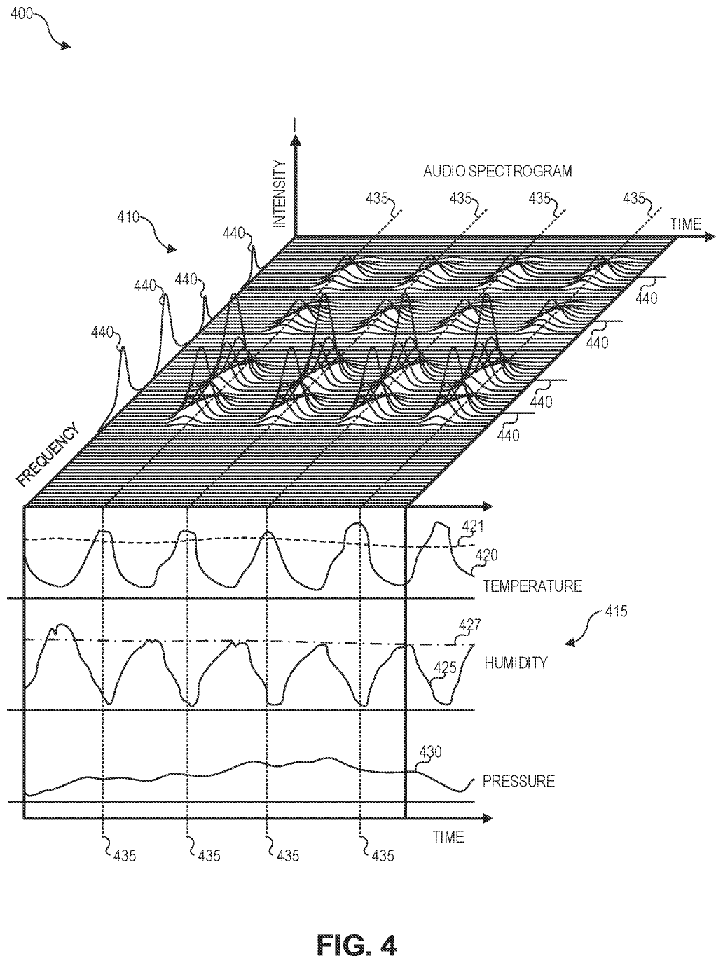

FIG. 4 illustrates example model input data 400 generated by a base unit including an audio spectrogram and environmental data, in accordance with embodiments of the disclosure. The input data 400 may be include: processed audio data 410 and environmental data 415 that are received from one or more sensors, such as sensor bar 110 of FIGS. 1-2. Environmental data 415 may include, but is not limited to: external temperature 420, internal temperature 421, external humidity 425, internal humidity 427, and/or ambient pressure 430. Input data 400 illustrates data generated over multiple cycles 435 of activity of a beehive.

Input data 400 may be generated continuously over time, for example, by sampling sensor data at a given sampling rate, such that dynamics of the system (e.g., beehive 300 of FIG. 3) may be captured without distortion or loss of information. In an illustrative example, input data 400 may exhibit periodicity on multiple scales, such as a time scale of hours and/or a time scale of days, in accordance with typical circadian rhythms of a beehive. In this way, input data 400 may be sampled on the order of seconds, minutes, or hours, without loss of information that would impair the functioning of ML models (e.g., ML models 140 of FIGS. 1-2). Such flexibility permits the sampling rate to be determined while taking into account system resources and characteristic patterns of the periodic system. In accordance with the Nyquist rate, audio data 410 may be sampled in segments at a rate that is twice the shortest frequency that includes meaningful information. This approach permits fine features of sound to be preserved in audio data 410, while also reducing the volume of audio data and preserving circadian dynamics of the periodic system being studied. For example, a circadian cycle of a beehive is typically on the order of a solar day, but sound generated by the beehive typically includes a broad range of frequencies from about 100 Hz up to and including about 3 kHz, making the Nyquist rate about 5-6 kHz. In an illustrative example, input data 400 are generated in one-minute segments across the period of one cycle 435 (e.g., a 24-hr cycle), such that a total of 96 one-minute segments of input data 400 are generated. Other sampling arrangements are contemplated, corresponding to the characteristic dynamics of the system being monitored or modelled.

In some embodiments, the sensor sampling rate for audio data 410 and environmental data 415 may differ. Also, a sampling rate may be dynamic to account for inactive periods of the system, such that input data 400 may be preferentially generated when the system is active. In the context of a beehive, bees tend to exhibit a diurnal sleep/wake cycle with as much as nine hours of quiet during nighttime, depending on location of the beehive and the season. In this way, while environmental data 415 continues to vary continuously overnight, audio data 410 includes relatively sparse information between active periods.

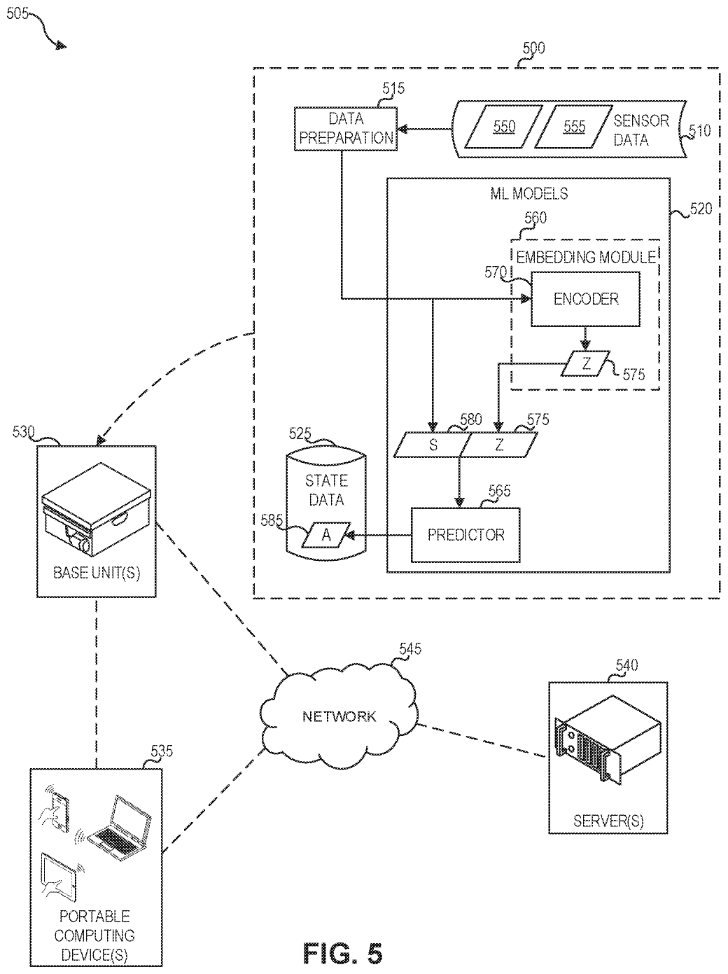

Audio data 410 is illustrated as a frequency spectrogram representing the intensity of sound registered by sensors (e.g., sensor bar 110 of FIG. 1, sensor bar 301 of FIG. 3) as a function of both frequency and time. A projection of the audio data 410 onto the frequency-intensity axes is illustrated to demonstrate that a spectrogram represents a transformation into frequency-space of a time-variant audio signal (e.g., a mel-spectrogram), such that a number of peak frequencies 440 are identified that are emitted by the system. Audio data 410 may include multiple peak frequencies 440 that may be time varying with different tendencies, such that monitoring one or two of the peak frequencies 440 individually may obscure dynamics of the system. In this way, machine-learning techniques, described in more detail in reference to FIGS. 5-8, may process spectrograms in a spectrogram sequence as an approach to isolating meaningful information from input data 400 that may be otherwise unintelligible to humans. In an illustrative example, broadening of a peak frequency 440 at 645 Hz and loss of a peak frequency 440 at 350 Hz are associated with low-disease severity in a beehive.

In some embodiments, spectrogram sequences may be generated from audio data 410 by segmenting audio data 410 into multiple audio segments. As the length in hours of a solar day may vary seasonally, the length in hours of the cycle 435 may also vary. In some embodiments, each constituent spectrogram describes an audio segment corresponding to a one-minute duration. In this way, sampling the plurality of audio segments generates an input sequence including a subset of the audio segments across the period of time. In some embodiments, generating the spectrogram sequence includes transforming acoustic signals picked up by the sensors (e.g., sensor bar 110 of FIG. 1).

In an illustrative example of a beehive, audio data 410 is sampled to generate a 56-second audio sample. The audio sample is converted into a .wav file and processed to obtain a full sized mel-spectrogram, which describes an array of 128 pixels by 1680 pixels, for a maximum frequency set at 8192 Hz, equivalent to half of the sampling rate of 16.28 kHz. The spectrogram is down-sampled by mean-pooling to a size of 61 pixels by 56 pixels, with 61 pixels representing the frequency dimension, and 56 pixels representing one-second time points. As bees typically generate meaningful sound up to a frequency of about 2.7 kHz the spectrogram is selectively cropped and subsampled to produce a square spectrogram, representing a 56 by 56 mel-spectrogram.

In some embodiments, the down-sampled spectrogram is normalized to include intensity values between zero and one. In contrast to conventional sound pattern analysis for speech recognition or genre-analysis, common transformations such as Mel-frequency cepstrum (MFCC) may be inappropriate for generating input data 400. For example, MFCC enforces speech-dominant priors that do not apply to sound data generated by non-human periodic systems, likely resulting in bias or data loss during dimensional reduction.

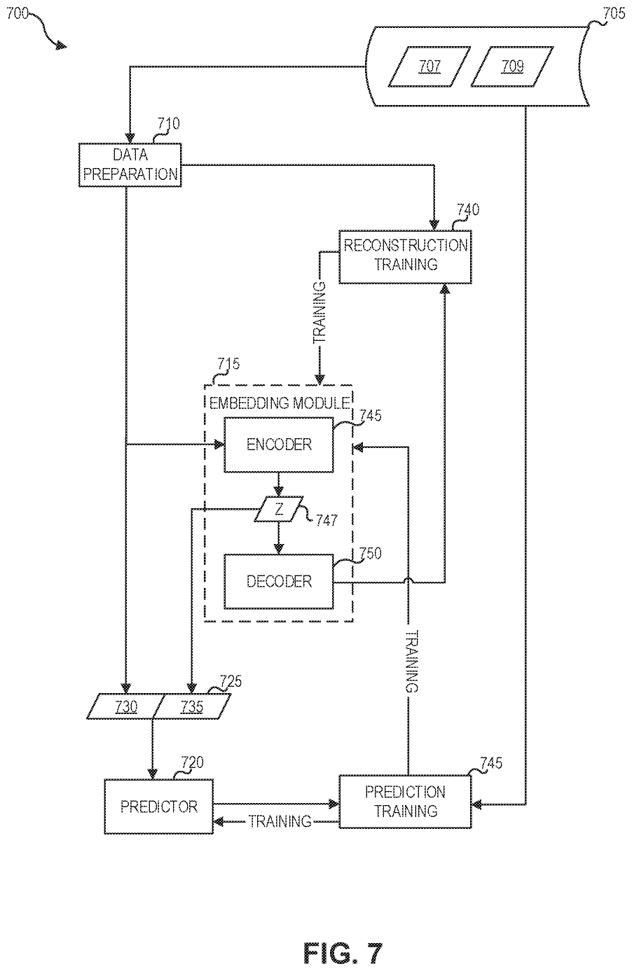

Environmental data 415 may include point estimates of humidity, temperature, or air pressure, measured over a period of time. Environmental data 415 provides insight into the state of the system by monitoring both internal and external conditions. For example, in a beehive, internal temperature 421 and internal humidity 427 are controlled through bee activity, such that internal environmental data of a healthy beehive exhibits negligible dynamics over multiple cycles 435. In this way, deviation from stable internal readings may signal an identifiable change in the state of the beehive. Similarly, external conditions may influence system dynamics, such that monitoring external conditions improves machine learning model predictions of system state. For example, bee colony behavior is temperature and humidity dependent, in that bees in the beehive shift from heating activities (body vibration) to cooling activities (wing fanning) in response to rising external temperature 420, as an approach to maintaining stable internal temperature 421 of the beehive. Similar to audio data 410, each constituent signal making up environmental data 415 may be normalized separately to a value between zero and one, as may be done with ground-truth data collected as part of training, described in more detail in reference to FIG. 7.

FIG. 5 illustrates a block flow diagram 500 including example connectivity of components of a system 505 for modelling the state of a periodic system, in accordance with embodiments of the disclosure. Block flow diagram 500 describes blocks for: data storage 510, data preparation and processing 515, generative-prediction network 520, and data output 525 operations associated with modelling the state of the periodic system. System 505 includes: a base unit 530, one or more portable computing devices 535, and one or more servers 540 that may communicate over a network 545 and/or directly. Base unit 530 may be an implementation of base unit 120 of FIGS. 1-2.

In some embodiments, base unit 530 includes electronic components for executing instructions, such as non-transitory computer-readable memory and one or more processors, to implement operations represented in block flow diagram 500. Description of the periodic system focuses on modelling the state of a beehive using sensor data collected from the beehive, as described in more detail in reference to FIGS. 1-4. It is understood that block flow diagram 500 may be similarly applied to other periodic systems, as previously described. For example, base unit 530 may be attached to a suspended roadway or bridge, a turbine, or other periodic system for which ground-truth state data is sparse.

Data storage 510 describes one or more data stores, such as flash memory or other memory devices to receive and/or store data generated by sensors (e.g., sensor bar 110 of FIG. 1). In some embodiments, data storage 510 is distributed across the system 505, for example by transmission (e.g., by wireless communication) between base unit 530 and portable computing device(s) 535. Sensor data stored in data storage 510 may be or include multimodal data generated by sensors, including but not limited to audio data 550 and environmental data 555.

Data preparation 515 describes one or more operations executed as part of generating model input data (e.g., input data 400 of FIG. 4), as described in more detail in reference to FIG. 4. For example, data preparation 515 may describe sampling, Fourier transform, down-sampling, cropping, normalization, segmentation, as well as other processes for preparing input sequences for generative-prediction network 520. In an illustrative example, data preparation 515 includes processing continuous sampled audio data across a given frequency range into a sequence of audio spectrograms, such that each audio spectrogram represents intensity information across the frequency range for a period of time. In some embodiments, spectrogram sequences describe periods of time on the order of seconds, minutes, hours, days, weeks, or more. Similarly, audio spectrograms may describe periods of time on the order of seconds, minutes, hours, days, weeks, or more, based at least in part on the dynamics of the system. It is understood that data preparation may generate different input data, based, for example, on characteristic dynamics of the system to be modelled.

For a beehive, the circadian cycle of a beehive may define the period of time described by the spectrogram sequence, the characteristic dynamics exhibited by the beehive may define the duration of each spectrogram, and the frequencies of sound generated by the beehive may define the sampling rate of audio data (e.g., audio data 410 of FIG. 4) generated. In some embodiments, the spectrogram sequence describes one circadian cycle of about 24 hours in about 100 spectrograms, and each spectrogram describes about one minute of sound sampled at about 16 kHz. In this context, the term “about” is used to describe a value ±10% of the stated value.

To balance capturing fine dynamics of periodic systems against the computational resource demand of processing larger datasets, data preparation 515 may include sampling audio data 550 and/or environmental data 555, for example, based on a determination of the Nyquist rate for each component signal. In some embodiments, an audio spectrogram is a square matrix of sound intensity values across 56 time points and 56 frequencies to describe one minute of activity in the system, with each time point describing one second of time. In some embodiments, a spectrogram sequence output by data preparation 515 includes 96 audio spectrograms covering a single circadian cycle of a beehive, such as a one-day period.

Spectrogram sequences may include multiple constituent spectrograms that may be treated as a sequence of frames to be inputted into a sequential embedding model trained to receive a frame and to generate a reduced-dimensional latent representation. While the example describes a sequence of 96 spectrograms, each representing 56 frequency channels and 56 time points, the size of each spectrogram and number (“t”) of spectrograms in the sequence may vary, based on the periodic system being modelled. For example, the spectrogram sequence may include 10 spectrograms or more, 20 spectrograms or more, 30 spectrograms or more, 40 spectrograms or more, 50 spectrograms or more, 60 spectrograms or more, 70 spectrograms or more, 80 spectrograms or more, 90 spectrograms or more, 100 spectrograms or more, 150 spectrograms or more, 200 spectrograms or more, 250 spectrograms or more, 300 spectrograms or more, 350 spectrograms, or more.

In turn, each spectrogram may be a square mel-spectrogram or a non-square mel-spectrogram of intensity data plotted against time and frequency for 10 time points or more, 20 time points or more, 30 time points or more, 40 time points or more, 50 time points or more, 60 time points or more, 70 time points or more, 80 time points or more, 90 time points or more, or 100 time points or more. Similarly, each spectrogram may include 10 frequencies or more, 20 frequencies or more, 30 frequencies or more, 40 frequencies or more, 50 frequencies or more, 60 frequencies or more, 70 frequencies or more, 80 frequencies or more, 90 frequencies or more, or 100 frequencies or more. The spectrogram for each timestep could also be combined through varying sampled frequencies to learn a multi-scale representation that captures finer features in one or more narrower frequency bands. Each frequency band may include a number of frequencies.

Generative-prediction network 520 includes an embedding module 560 and a predictor 565. The embedding module 560 includes an encoder model 570 that is trained to generate a latent representation 575 (“Z”) from a spectrogram sequence generated by data preparation 515. The Predictor model 565 may include one or more machine learning models, including but not limited to classifiers or linear predictors, trained to generate state data 585 (“A”) describing the periodic system. In some embodiments, the predictor model 565 may receive as input data the latent representation 575 accompanied by environmental data 580 (“S”) received from data store 510, for example, via data preparation 515. In some cases, latent representation 575 and environmental data 580 are concatenated into an input sequence that is provided to the predictor model 565. In this context, the term “latent representation” refers to reduced dimensional data that models relevant information describing the state data 585 while omitting at least some non-meaningful data, such as noise.

State data 585 may be output from generative-prediction network 520 through one or more data output 525 operations. As illustrated in FIG. 5, state data 585 is output to data store 510. Data store 510 may be onboard base unit 530 or it may be or include memory on portable computing device(s) 535, server(s) 540, or other remote physical or cloud storage systems. In some embodiments, output 525 operations include generating notifications, alerts, visualizations, push messages, or other information to be provided via electronic communication. In an illustrative example, a bee keeper may receive via portable computing device 535 a message indicating that the base unit has identified a disease affecting the beehive that exceeds a threshold level for warning the beekeeper (e.g., parasitic infestation, colony collapse, etc.)

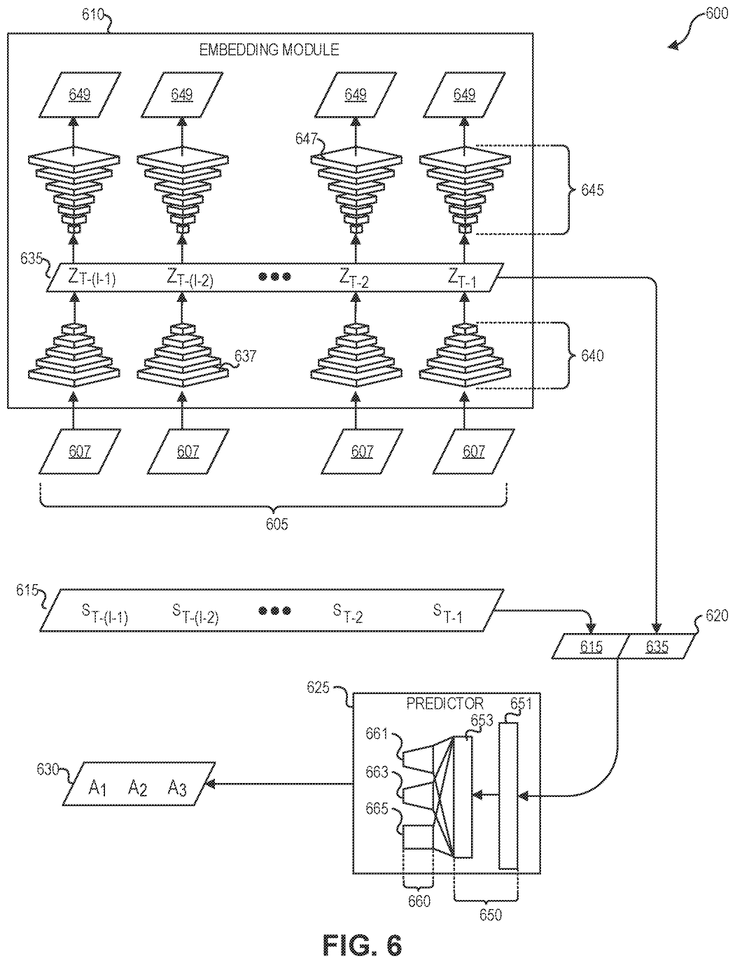

FIG. 6 illustrates data flows through an example generative-prediction network 600 including constituent models for modelling the state of a periodic system, in accordance with embodiments of the disclosure. Generative-prediction network 600 includes: a spectrogram sequence 605, an embedding module 610, environmental data 615, an input sequence 620 inputted to a predictor 625 and an output 630 generated by the predictor 625. Generative predictive network 600 represents one implementation of generative predictive network 520, embedding module 610 represents one implementation of embedding module 560, and predictor 625 represents an implementation of predictor 565.

Spectrogram sequence 605 includes a series of spectrograms 607, as described in more detail in reference to FIGS. 4-5. In some embodiments, embedding module 610 may be or include one or more ML models configured to reduce the dimensions of spectrograms 607 as part of generating a latent representation 635 (e.g., latent representation 575 of FIG. 5).

For example, where spectrogram sequence 605 describes audio data generated using sensors positioned in a beehive (e.g., sensor bar 110 of FIG. 1), embedding module 610 may be trained to generate latent representation 635 that preserves information from the frequency spectrum indicative of disease affecting the beehive, population of the beehive, disease severity, or other information of interest to beekeepers. It is understood that latent representation 635 includes multiple entries (e.g., “Z_{T-1}” where “T−1” is the length of spectrogram sequence 605 and “T” represents the current time step, analogous to time=t₀, such that latent representation may be or include a fixed length vector of real values with a length equal to that of spectrogram sequence 605.

Latent representation 635 may preserve influential information in a form that is not intuitively comprehensible by humans or rules-based procedural models. Predictor 625 receives latent representation 635 as an input from which comprehensible output 630 data is generated. In this way, latent representation 635 may represent a concatenated latent space including mean and standard deviation vectors that may be combined by various approaches including, but not limited to, re-parametrization, to produce a fixed-length vector of real values. Latent representation 635 may represent concatenated latent variables from all audio samples for a period of time (e.g., one cycle 435 of FIG. 4). In an illustrative example, latent representation 635 for audio collected from a beehive includes concatenated latent variables for 96 audio samples of one-minute duration collected over one day.

In some embodiments, embedding module 610 includes a convolutional variational autoencoder. Latent representation 635 may be generated as output of multiple encoders 640 including one or more convolutional layers 637 with shared parameters across the inputs of the spectrogram sequence 605. As spectrograms 607 are two dimensional inputs analogous to image data, each encoder 640 may be or include a convolution neural network, as part of the variational autoencoder. The number of layers (e.g., depth) of each encoder 640 may be determined as a balance between improved pattern identification and computational resource demand, determined as part of model design and training. In this way, each encoder 640 may include two or more, three or more, four or more, five or more, six or more, seven or more, eight or more, nine or more, or ten or more convolutional layers 637. In some embodiments, each encoder 640 includes five convolutional layers 637

Embedding module 610 may also include multiple decoders 645 as part of a sequential architecture for encoder 640 training, as described in more detail in reference to FIG. 7. Decoders 645 may be used during training of generative-prediction network 600 to reconstruct spectrograms 607 from latent representation 635. Decoders 645 include multiple transposed-convolutional layers 647 that may be trained with encoder 640 to generate reconstructed spectrograms 649 (e.g., mel-spectrograms). As part of training embedding model 610 and generative-prediction network 600, reconstructed spectrograms 649 are compared to spectrograms 607 as part of reconstructing spectrogram sequence 605 from latent representation 635. As with encoder 640, the number of layers (e.g., depth) of decoder 640 may be determined as a balance between improved reconstruction accuracy from latent representation 635 and constraints on computational resource demand, determined as part of model design and training. In this way, decoder 645 may include two or more, three or more, four or more, five or more, six or more, seven or more, eight or more, nine or more, or ten or more transposed-convolutional layers 647. In an illustrative example, decoder 645 includes seven transposed-convolutional layers 647 for reconstructing latent representation 635.

As part of generating input sequence 620, environmental data 615 is concatenated with latent representation 635. Input sequence 620 may be a fixed-length sequence of real values. Environmental data 615 may be a sequence of real values of equal, greater, or lesser size than latent representation 635. In some embodiments, latent representation 635 includes concatenated latent variables from 96 spectrograms 607 and environmental data 615 includes 96 samples, such as temperature, humidity, and pressure, sampled at corresponding time points (e.g., point estimates) across the sampling period described by spectrogram sequence 605 (e.g., one circadian cycle).

In some embodiments, predictor 625 includes a shallow feed-forward network 650 to prevent overfitting and to model simple temporal dynamics over the period of time described by spectrogram sequence 605. Shallow feed-forward network 650 includes multiple layers including, but not limited to, an input layer 651 and an activation layer 653. In some embodiments, predictor 625 implements a deep feed-forward network by including one or more hidden layers between input layer 651 and activation layer 653.

Predictor 625 takes in input sequence 620. In some embodiments, input sequence 620 includes concatenated latent variables from 96 audio samples, along with a corresponding 96 samples of internal and/or external environmental data, which includes temperature, humidity, and pressure. Predictor 625 may use environmental data 615 to normalize for interactions between environment and system dynamics. For example, in a beehive, predictor 625 may use environmental data 615 to control for temperature, pressure, and/or humidity effects on bee activity, rather than for predicting the momentary population and disease status of the beehive, given that activity may vary in response to changes in temperature and/or humidity.

Predictor 625 is to multiple predictor heads 660. Predictor heads 660 may be or include ML models receiving outputs of shallow feed-forward network 650. As such, each predictor head 660 of predictor 625 may be trained to output a respective state parameter (“A”) of the periodic system. Output 630 of predictor 625 includes a vector of outputs from predictor heads 660, representing values for a corresponding number of system state parameters.

Learned parameters may be shared between shallow feed-forward network 650 and predictor heads 660. Parameter sharing may improve and/or encourage shared representation learning and regularize model behavior based on a multi-task objective. In addition, parameter sharing in predictor 625 may reduce overfitting and may capture similar representations. In an illustrative example of a beehive, prediction tasks for disease status/severity and beehive population may be similar.

In an illustrative example, predictor heads 660 include: a first head 661 trained to predict a number of frames of each frame type, a second head 663 trained to predict a disease severity, and a third head 665 trained to predict a disease type. First head 661 and second head 663 include shallow linear predictor models. Third head 665 includes a classifier model. In the context of the quantity of frames, the first head 661 may be trained to predict a number of frames in the beehive that contain honey and a number of frames in the beehive that contain brood. The beehive may include a queen excluder that separates brood chamber 305 from honey super chamber 310, so the first head 661 may be trained to predict how many frames in each chamber are occupied, from which the population of the bee hive can be estimated.

The number and type of predictor heads 660 may be configured based at least in part on the number and type of state parameters to be predicted from input data. For a beehive, for example, predictor heads 660 may include, but are not limited to, models for predicting probability of parasitic infestation, probability of queenlessness, type of parasitic infestation, probability of disease, type of disease, frame type, or bee activity. In this way, it is understood that the type of predictor head 660 included is related to the type of prediction task, where probability or extent may be predicted by a linear predictor and type may be predicted by a classifier.

FIG. 7 illustrates a block flow diagram 700 for training the generative predictor network to predict the state of a periodic system, in accordance with embodiments of the disclosure. Block flow diagram 700 includes: a data store 703, data preparation 710, an embedding module 715, a predictor 720, and an input sequence 725 including a concatenated environmental data sequence 730 and latent space variable sequence 735 generated by embedding module 715. Training may be implemented by reconstruction training 740 and prediction training 745.

Data store 705 may be or include one or more non-transitory memory devices storing training data. In contrast to data stores described in reference to FIG. 5, model training described in reference to FIG. 7 may be implemented remotely from the system being monitored. For example, while trained models and sensor data may be stored locally on a base unit (e.g., base unit 530 of FIG. 5). Training, which may include thousands of iterations and/or human expert involvement to prepare labeled and unlabeled training data, for example, by synthesizing data for unsupervised learning and/or by stratifying labeled data to address bias in learned parameters. For example, training data may include training sets 705 and validation sets 707 that may be used to train embedding module 715 and/or predictor 720.

Quality control may form a part of data preparation for training. For example, training sets 707 and validation sets 709 may be prepared by excluding incomplete samples, for example, where sensors exhibit hardware issues resulting in incomplete data over a period of time of hours, days, weeks, or longer. Similarly, where some data may be available from incomplete sensor data, for example, where humidity data is unavailable, but audio and temperature data is available, multiple periods of time of incomplete data may be excluded from training sets 707 and/or validation sets 709.

In an illustrative example, a validation set 709 may be or include an inspection-paired (e.g., a labeled) dataset of tens, hundreds, thousands, or more samples across tens, hundreds, thousands, or more hives, spanning tens, hundreds, or more days. In cases where validation set 709 includes a relatively limited sample size, multi-fold validation with all models may be evaluated as part of training. Where ground-truth data is unavailable for a period of time, sensor data may be removed.

To reduce cross contamination between training data and test data due to sensor similarities, which may influence training and inference, training may be implemented using training sets 707 and validation sets 709 from different systems/sensors than the test system. The approach of training on data collected from systems/sensors different from the system being modelled may improve generalization of prediction across multiple similar systems, for example, by training models to identify system-independent factors without fine-tuning of models. In an illustrative example, different beehives may be monitored by base units provided with the same generative-prediction model trained to predict a state of a beehive (e.g., output 630 of FIG. 6), as described in more detail in reference to FIG. 6.

As part of few-shot learning techniques for training predictor 720, cumulative distribution functions may be computed for percentage difference between predictions and inspections as an approach to examining the fraction of predictions that fall within the ground truth error lower bound. Generally, a higher value of the lower bound indicates more restrictive training, while a lower value of the lower bound indicates more permissive training. The lower bound may be about ±1%, about ±5%, about ±10%, about ±15%, about ±20%, about ±25%, about ±30%, about ±35%, or more of the assigned label. In an illustrative example, the ground truth error lower bound for training predictor 720 to model a state of a beehive may be 10%. As part of preparing validation set 709, validation sets 709 may be partitioned for use during multiple training iterations. Validation scores for each partitioned validation set 709 may be computed for each training iteration to provide insight into evolution of model training landscapes and assess model overfit.

As described in reference to FIG. 6, embedding module 715 may be or include a variational autoencoder including an encoder 745 and a decoder 750. Encoder 745 may include multiple encoders trained to generate a latent representation from audio spectrograms generated at data preparation 710. For example, embedding module 715 may receive a spectrogram sequence including 96 spectrograms that may be individually encoded by 96 encoders sharing parameters.

Embedding module 715 may be trained to process each sample separately, which may include not capturing temporal dynamics explicitly. Where time-localized dynamics are sought, rather than longitudinal dynamics of the system, embedding module 715 may learn feature filters that are less dependent on downstream prediction loss, which can bias the model due to limited labeled data. Similarly, decoder 750 may be trained to reconstruct input spectrograms from latent variables generated by encoders 745. Embedding module 715 may be trained via variational inference based on minimizing the negative log likelihood of the reconstructed output of decoder 750. The output of the reconstruction may be a 56×56 downsampled mel-spectrogram similar to spectrograms generated during data preparation 710, thereby facilitating comparison with the model input sequence.

Embedding module 715 may be trained jointly (e.g. both encoder 745 and decoder 750) via sample reconstruction training 740 using an evidence lower bound objective (ELBO) function, described in Equation (1) as well as a global prediction loss across a given period of time, backpropagated through latent variables 747.

log p(x)≥ [symbol] (x)=E_{z˜q(Z|X)}log p(x|z)−D_{KL}[q(z|x)∥p(z)] (1)

where [symbol] is the evidence lower bound (ELBO function), log p(x) is the log-evidence for the model considered, q(z|x) is a distribution over unobserved variables, Z, and approximates p(x|z), the true posterior, given observed data X D_{KL} [q(z|x)∥p(z)] is the Kullback-Leibler divergence, which is a measure of dissimilarity between q and the true posterior. E is the expected values of the unobserved variables.

Encoders 740 may be trained for hundreds, thousands, tens of thousands, hundreds of thousands, or more iterations to learn stable latent representations 747 before prediction gradients are propagated as part of few-shot training. In some embodiments, encoders 740 are trained using unlabeled data as an approach to increase generalization. For example, in systems where embedding module 715 generates latent representation 747 from 96-sample spectrogram sequences generated from audio data collected from a beehive, reconstruction training 740 training may include about 40,000 iterations to learn a stable latent representation 747 before prediction gradients are propagated. As such, it is contemplated that embedding module 715 and predictor 720 may be jointly trained. For example, while embedding module 715 may learn stable latent representations 747 by unsupervised learning during reconstruction training 740, encoder 745 and/or decoder 750 models may be trained by backpropagation of gradients from prediction training 745 generated using ground truth data.

The predictor may be trained using multi-task prediction losses. Prediction training 745 may continue until all losses have converged and stabilized. Multi-task objective functions may include, but are not limited to, Huber loss (Equation 2) for regression tasks and categorical cross-entropy (Equation 3) for classification tasks. For example, for modelling a state of a beehive, Huber loss may be used for frame type and disease severity regressions, while categorical cross-entropy may be used for disease classification.

$$L ( y , f ( x ) ) = \{ \begin{matrix}{\frac{1}{2} [ y - f ( x ) ]}^{2} for \vert y - f ( x ) \vert \leq δ , \\ δ ( \vert y - f ( x ) \vert - \frac{6}{2} ) otherwise\end{matrix} \qquad ( 2 )$$

where |y−f(x)|=δ refers to the residuals, or the difference between observed “y” and predicted values “f(x)”. In turn, categorical cross-entropy loss is described for two probability distributions output by predictor 720 by:

L(yᵢ, [symbol] )=−Σᵢ₌₁^{t}yᵢ·log(ŷₗ) (3)

where ŷₗ is the i^{th} scalar value in the model output, yᵢ is the corresponding target value, and t is the number of scalar values in the model output ŷₗ. In some embodiments, the output of predictor 720 (e.g., predictor heads 560 and/or activation layer 553 of FIG. 5) may be rescaled using an activation function (e.g., softmax), such that the output is positive.

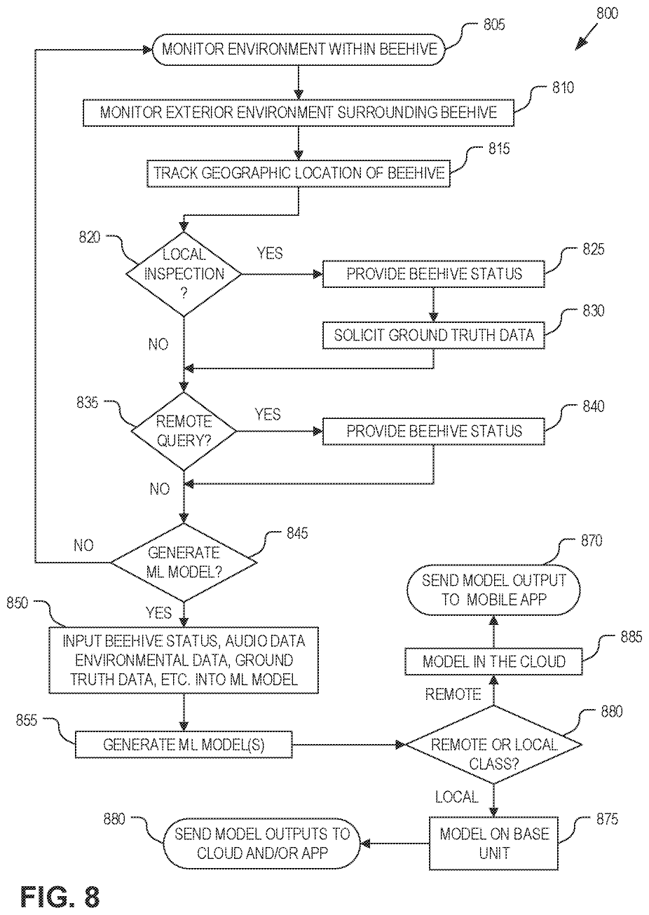

FIG. 8 is a flow chart illustrating an example process 800 for monitoring the state of a beehive using sensors and ML models, in accordance with embodiments of the disclosure. The order in which some or all of the process blocks appear in process 800 should not be deemed limiting. Rather, one of ordinary skill in the art having the benefit of the present disclosure will understand that some of the process blocks may be executed in a variety of orders not illustrated, or even in parallel.

In a process block 805, a sensor (e.g., sensor bar 110 of FIG. 1) operates to monitor (e.g., continuously, periodically, or on-demand) the interior of a beehive (e.g., beehive 300 of FIG. 3). In various embodiments, monitoring the interior environment includes recording hive activity via audio sensors (e.g., microphone 240 of FIG. 2) and/or monitoring various other interior environmental characteristics using interior environmental sensors (e.g., environmental sensors 245-265 of FIG. 2). In one embodiment, the data (e.g., recorded audio data and sensor readings) are recorded into memory (e.g., memory 205 of FIG. 2) of a base unit (e.g., base unit 115 of FIG. 1) for storage and/or processing.

In a process block 810, base unit 115 operates to monitor (e.g., continuously, periodically, or on-demand) the exterior environment surrounding the beehive. In various embodiments, monitoring the exterior environment includes monitoring various exterior environments characteristics using exterior environmental sensors (e.g., exterior environmental sensors 230-239 of FIG. 2). Again, the exterior sensor data may be temporarily stored into onboard memory (e.g., onboard memory 205 of FIG. 2). Along with the sensor data, base unit 115 may identify the geographical location of the beehive using GPS (e.g., GPS 220 of FIG. 2) (process block 815). Since commercial beehives are often transported great distances throughout the year, location tracking can help correlate sensor readings to geographic location, local weather, local crops/vegetation, known sources of pollution, etc.

In one embodiment, a beekeeper (or other field technician) can physically inspect individual beehives using a mobile computing device (e.g., mobile computing device 131 of FIG. 1) equipped with NFC capabilities and a mobile application (mobile application 130 of FIG. 1). For example, the beekeeper can tap or scan base unit 115 with mobile computing device 131 (decision block 820) to obtain the data and sensor readings related to the status and health of a particular beehive. Ground truth data related to the beekeeper's own observations of the hive may also be solicited by mobile application 130 (process block 830). After collecting the data (e.g., sensor readings, audio data, ground truth data, and any other ancillary data), mobile application 130 may transmit the data (or summarized analysis thereof) to a cloud-based application (e.g., cloud-based application 135 of FIG. 1). Alternatively (or additionally), base unit 115 may be physically removed from a mount (e.g., mount 120 of FIG. 1) for charging and large data download to a computer via a wired connection (e.g., USB-C, etc.), and then base unit 115 is subsequently recoupled with mount 120.

If a remote query of a particular beehive (or group of beehives) is desired (decision block 835), then the health status of the beehive may be obtained via cellular data communications. For examples, the remote query may come from cloud-based application 135 as part of a routine, periodic, or on-demand retrieval of data. Alternatively, a user of mobile application 130 may request a remote query of the health status of a particular beehive or group of beehives. A remote query from mobile application 130 may come indirectly via cloud-based application 135 or may operate as a direct peer-to-peer communication session with base unit 115.

In embodiments using machine learning to model and classify the health status of a beehive (decision block 845), the collected data (e.g., interior and exterior environmental sensor data, GPS location, audio data, etc.) is combined with the collected ground truth data and other ancillary data as input into an ML model (e.g., generative predictor network 600 of FIG. 6) for training (process block 850), as described in more detail in reference to FIG. 7 to prepare a trained ML model (process block 855).

In a decision block 860, the ML model may be operated remotely by cloud-based application 135 (process block 865) and the analysis sent to mobile application 130 for review by the beekeeper (process block 870). Alternatively (or additionally), the inference may be executed locally onboard base unit 115 by ML classifier 140 (process block 875). In this embodiment, base unit 115 sends the classifications and/or recommendations to cloud-base application 135 and/or mobile application 130 rather than transmitting underlying raw data (process block 880). This embodiment has the benefit of conserving power and bandwidth due to continuous, large volume transfers of the raw data. Of course, ML application 140 may also be integrated with mobile application 130 as a sort of semi-local classification.

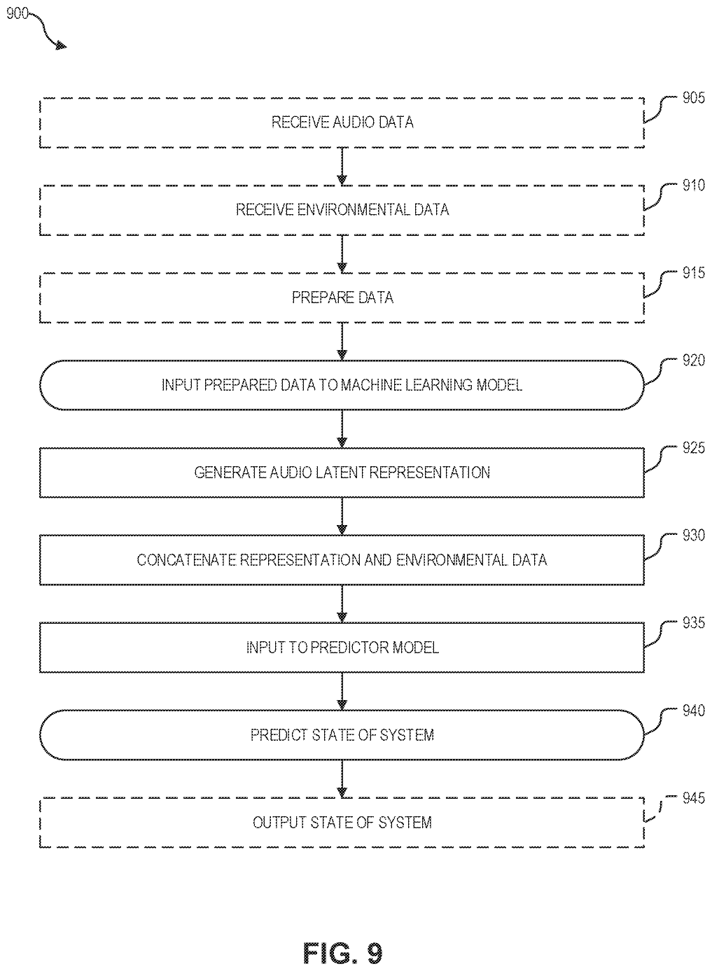

FIG. 9 is a flow chart illustrating a process 900 for predicting the state of a periodic system during inference by ML models, in accordance with embodiments of the disclosure. The order in which some or all of the process blocks appear process 800 should not be deemed limiting. Rather, one of ordinary skill in the art having the benefit of the present disclosure will understand that some of the process blocks may be executed in a variety of orders not illustrated, or even in parallel.

Process 900 may include one or more optional processes associated with data collection and preparation (e.g., data preparation 515 of FIG. 5 and data preparation 710 of FIG. 7) operations and/or output processes. In some embodiments, process 900 includes receiving audio data (e.g., audio data 410 of FIG. 4) at process block 905. Receiving audio data, as described in more detail in reference to FIGS. 4-5, may include monitoring sound generated by the periodic system using one or more sensors (e.g., sensor bar 110 of FIG. 1) that may be incorporated into, disposed on, and/or located within acoustic range of the periodic system. In some embodiments, where the system is a beehive, the sensors are integrated into sensor bar 110 and integrated into a frame (e.g., frame 145 of FIG. 1).

In some embodiments, process 900 may optionally include receiving environmental data (e.g., environmental data 415 of FIG. 4) at process block 910. As described in more detail in reference to FIG. 4, collecting environmental data may include monitoring ambient and/or internal conditions of the periodic system. In the example of a Beehive, external and internal conditions provide different meaningful information, such as environment-related dynamics in bee activity and homeostatic capacity of the beehive to maintain internal conditions. Environmental data may improve performance of ML models (e.g., embedding module 560 of FIG. 5 and predictor 565 of FIG. 5). In some embodiments, where the periodic system is a beehive, audio data and environmental data are received from a sensor bar (e.g., sensor bar 110) having a size and a shape to fit within the beehive, the sensor bar including at least one acoustic sensor and at least one environmental sensor.

In some embodiments, process 900 may optionally include preparing audio data and environmental data for input to one or more ML models at process block 915. As described in more detail in reference to FIG. 4, FIG. 5, and FIG. 7, data preparation may include operations for transforming audio data into a spectrogram sequence (e.g., spectrogram sequence 605 of FIG. 6) including multiple spectrograms (e.g., spectrograms 607 of FIG. 6). In some embodiments, data preparation includes sampling audio data across a period of time, such as a 24-hour period, a solar day, or another period of time that captures dynamics of the periodic system, and preparing two dimensional spectrograms that are suitable for inputting to convolutional neural network models, such as convolutional variational autoencoders. In some embodiments, data preparation for a Beehive includes sampling audio data across one day or one circadian cycle to generate a spectrogram sequence including 96 spectrograms corresponding to about a one minute duration, where each spectrogram includes a 56×56 array of intensity information expressed as a function of both time and frequency. Similarly, environmental data may be sampled to correspond to the timepoints described by the spectrogram sequence.

At process block 920, process 900 includes inputting the spectrogram sequence to a machine-learning (ML) model trained to generate a latent representation from audio data (e.g., latent representation 575 of FIG. 5) from the spectrogram sequence (process block 925). As described in more detail in reference to FIG. 5, generating the latent representation may include reducing the dimensionality of input data to generate a fixed-length sequence of real values. In some embodiments, the ML model includes an embedding module (e.g., embedding module 560 of FIG. 5 and embedding module 610 of FIG. 6). The embedding module may be or include a convolutional variational autoencoder, trained to generate the latent representation as an output of an encoder (e.g., encoder 640 of FIG. 6).

At process block 930, the latent representation is concatenated with environmental data to define an input sequence (e.g., input sequence 620 of FIG. 6). The input sequence may include input data including environmental data for each of the spectrograms included in the spectrogram sequence. In some embodiments, the latent representation includes one entry for each spectrogram in the spectrogram sequence and the environmental data is a sequence of equal length to the latent representation.

At process block 935, the input sequence is inputted to a predictor (e.g., predictor 565 of FIG. 5 and predictor 625 of FIG. 6). In some embodiments, the predictor is a fully connected feed-forward neural network, such as a shallow feed-forward network (e.g., shallow feed-forward network 650 of FIG. 6). The predictor may also include one or more predictor heads (e.g., predictor heads 660 of FIG. 6). Each predictor head may be or include a machine learning model, such as a regression or classifier model, trained to predict a state parameter of the periodic system from an output of an activation layer (activation layer 653 of FIG. 6) of the shallow feed-forward network. In some embodiments, where the periodic system is a beehive, the predictor heads include shallow linear predictors to predict frame-type and disease severity and a classifier to predict disease type. The predictor model may include additional and/or alternative predictor heads that may be trained, jointly with the embedding module, to predict other state parameters of the periodic system, as described in more detail in reference to FIG. 7.

At process block 940 the input sequence is used to predict a state of the periodic system. In some embodiments, the shallow feed-forward network normalizes the latent representation with respect to the environmental data, as an approach to accounting for confounding environmental effects on system behavior. In the example of a beehive, bees tend to exhibit reduced foraging activity at lower temperature. In some embodiments, to avoid confounding cold-weather behavior patterns with reduced beehive vitality, the predictor model is trained to normalize for temperature when predicting colony health. The output of the shallow feed forward network is then provided to the predictor heads to individually predict the state parameters describing the system as a multi-task objective. The individual outputs of the predictor heads together define the state of the periodic system, which may be outputted at process block 945.

In some embodiments, process 900 may optionally include one or more output operations, as described in more detail in reference to FIG. 1, FIG. 5, and FIG. 8. For example, output operations at process block 945 may include, but are not limited to, generating a notification describing the state of the periodic system and sending the notification to a network or to a mobile electronic device. In an illustrative example, the ML models described are optimized for edge devices such as a base unit attached to the system being monitored. In this example, the output of the base unit includes the state of the periodic system, but output of the base unit may also include prepared data, and/or raw sensor data. The notification may be or include information describing the state of the periodic system, which may include pushing the notification through a cellular network to a smartphone held by an inspector, uploading the notification to a network to be transferred to a server, and/or transmission over near-field communication (e.g., Bluetooth) to a mobile electronic device paired with the base station.

In some embodiments, output operations include determining when a monitored state parameter is exceeding a threshold, beyond which an intervention is due. For example, where the system being monitored is a beehive, output operations may include determining that the beehive is suffering from a disease for which the disease severity is outside a threshold for the disease type. Subsequent the determination, output operations include, but are not limited to, generating an alert describing the disease type and an indication of the disease severity and communicating the alert to a mobile computing device.

The system may automatically (e.g., without human intervention) identify when the periodic system being monitored needs intervention to address the cause of the issue. For a diseased beehive, for example, intervention may include, but is not limited to, opening the beehive to confirm the model output and applying an appropriate remedy, such as mite treatment, removing infested combs, applying a bee-safe fungicide, or other treatments typically applied to address beehive diseases.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible machine-readable storage medium includes any mechanism that provides (i.e., stores) information in a non-transitory form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A computer implemented method for modeling a state of a periodic system, the method comprising:
inputting a spectrogram sequence to a machine-learning model trained to generate a latent representation from the spectrogram sequence, wherein the spectrogram sequence comprises a plurality of audio spectrograms representing sound generated by the periodic system;
outputting the latent representation from the machine learning model;
concatenating the latent representation with environmental data describing environment of the periodic system, together defining an input sequence;
inputting the input sequence to a predictor model trained to predict a state of the periodic system from the input sequence; and
predicting the state of the periodic system with the predictor model.

2. The method of claim 1, wherein the periodic system comprises a beehive, the spectrogram sequence comprises audio data representing sound generated by the beehive during a period of time, and the environmental data is acquired during the period of time.

3. The method of claim 2, wherein the audio data and the environmental data is received from a sensor bar having a size and a shape to fit within the beehive, the sensor bar including at least one acoustic sensor and at least one environmental sensor.

4. The method of claim 2, wherein the period of time corresponds to a circadian cycle of the beehive, and wherein generating the spectrogram sequence comprises:
sampling the audio data to generate a plurality of audio segments across the circadian cycle; and
generating the spectrogram sequence using the plurality of audio segments.

5. The method of claim 1, wherein the plurality of audio spectrograms comprise mel-spectrograms.

6. The method of claim 1, wherein the machine-learning model is a convolutional variational autoencoder, comprising an encoder model trained to generate the latent representation from the spectrogram sequence.

7. The method of claim 6, wherein the encoder model is trained using a plurality of outputs of the predictor model, the plurality of outputs being generated using labeled ground truth data.

8. The method of claim 1, wherein the predictor model comprises a fully connected feed-forward neural network, and wherein an output layer of the predictor model comprises a plurality of predictor heads.

9. The method of claim 8, wherein the periodic system is a beehive, and wherein the plurality of predictor heads comprises:
a first head trained to predict a first number of honey super frames, a second number of brood frames, or both the first number and the second number;
a second head trained to predict a disease severity; and
a third head trained to predict a disease type.

10. The method of claim 9, wherein the first head and the second head are shallow linear predictor models and wherein the third head is a classifier model.

11. The method of claim 1, wherein the environmental data comprise point estimates of humidity, temperature, or air pressure, measured over a period of time.

12. The method of claim 1, further comprising:
generating a notification describing the state of the periodic system; and
outputting the notification to a network.

13. At least one machine-accessible storage medium that provides instructions that, when executed by a machine, will cause the machine to perform operations comprising:
inputting a spectrogram sequence to a machine-learning model trained to generate a latent representation from the spectrogram sequence, wherein the spectrogram sequence comprises a plurality of audio spectrograms representing sound generated by the periodic system;
outputting the latent representation from the machine learning model;
concatenating the latent representation with environmental data describing the periodic system, together defining an input sequence;
inputting the input sequence to a predictor model trained to predict a state of the periodic system from the input sequence; and
predicting the state of the periodic system with the predictor model.

14. The at least one machine-accessible storage medium of claim 13, wherein the periodic system comprises a beehive, the spectrogram sequence comprises audio data representing sound generated by the beehive during a period of time, and the environmental data is acquired during the period of time.

15. The at least one machine-accessible storage medium of claim 14, wherein the audio data and the environmental data are received from a sensor bar having a size and a shape to fit within the beehive, the sensor bar including at least one acoustic sensor and at least one environmental sensor.

16. The at least one machine-accessible storage medium of claim 13, wherein the period of time corresponds to a circadian cycle of the beehive, and wherein generating the spectrogram sequence comprises:
sampling the audio data to generate a plurality of audio segments across the circadian cycle; and
generating the spectrogram sequence using the plurality of audio segments.

17. The at least one machine-accessible storage medium of claim 13, wherein the machine-learning model is a convolutional variational autoencoder, comprising an encoder model trained to generate the latent representation from the audio spectrogram data.

18. The at least one machine-accessible storage medium of claim 13, wherein the predictor model comprises a fully connected feed-forward neural network, and wherein an output layer of the predictor model comprises a plurality of predictor heads.

19. The at least one machine-accessible storage medium of claim 18, wherein the periodic system is a beehive, wherein the state of the beehive comprises a plurality of outputs of the plurality of predictor heads, and wherein the plurality of predictor heads comprises:
a first head trained to predict a first number of honey super frames, a second number of brood frames, or both the first number and the second number;
a second head trained to predict a disease severity; and
a third head trained to predict a disease type.

20. The at least one machine-accessible storage medium of claim 18 wherein the instructions, when executed by the machine, further cause the machine to perform operations comprising:
determining that the disease severity is outside a threshold for the disease type;
generating an alert describing the disease type and an indication of the disease severity; and
communicating the alert to a mobile computing device.
